(19) United States
(12) Patent Application Publication
(10) Pub. No.: US 2006/0265667 A1
(43) Pub. Date: Nov. 23, 2006

(54) Method and user interface for handheld device, useful for matching games such as lotteries or scratch games

(76) Inventor: Bryan G. Hughes, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/134,992

(22) Filed: May 23, 2005

(51) Int. Cl. G06F 9/00

(52) U.S. Cl. 715/810

(57) ABSTRACT

A user interface facilitates the presentation and/or playing of matching games on small displays commonly associated with handheld or mobile communications devices. In one aspect, identification of a name from a list of available picks causes the presentation of an image or graphic directly or indirectly associated with the identified name. Thus, identification of a sports team may display a team logo or sponsor logo, or identification of a corporate name may display a corporate logo or sponsor logo. The logo may replace the identified pick in the display, or be displayed in a separate field. Selection of the identified name is used to populate a field of a list of selected picks for comparison with a winning combination.

### BACKGROUND OF THE INVENTION

1. Field of the Invention

This disclosure generally relates to user interfaces for devices having small displays, and more particularly relates to user interfaces useful for playing matching games such as lotteries or scratch and match games via handheld and/or mobile wireless communications devices.

2. Description of the Related Art

Handheld or mobile communications devices are becoming ubiquitous. Examples of such devices include cellular telephones and/or personal digital assistants (PDAs), for example Blackberry devices sold under the marks Blackberry®, Palm Pilot®, Treo®, IPaq®. These devices are typically handheld and battery, and employing wireless communications using any of a variety of wireless communications frequencies (e.g., 800 MHz, 1900 MHz) and/or protocols (e.g., TDMA, CDMA, GSM).

These devices typically share a number of limiting aspects, including the size of the display, and the size and number of user interface controls. For example, displays on PDAs are typically on the order four square inches, while displays on cellular telephones are typically as small as one square inch. Typical cellular telephones include a number of user activatable keys including, for example, a standard 12 key keypad with keys corresponding to the digits 0-9 and the special characters * and #. Cellular phones may also typically include a power button or key, as well as keys for navigating menus. Typically, PDAs include a number of user activatable keys including, for example, a set of keys that replicate standard typewriter layout (e.g., QWERTY) which may include one or more shift or special function keys. PDAs may also typically include a power button or key, as well as keys or other user input devices for navigating menus. Navigating a menu is typically associated with a movement of a cursor displayed on a display with respect to a list of items or icons to identify an item or icon and/or select the identified item or icon.

Other user input devices may include a thumb activated wheel, which may be rotated, for example for scrolling down a list to identify an item or icon, and which may be depressed or otherwise activated to select the identified item or icon. Such scrolling is typically associated with a movement of a cursor displayed on the display with respect to the list or icons. User input devices may alternatively, or additionally, include a joystick, for example a finger or thumb activated joystick, which may be toggled into a number of directions to move a cursor displayed by the display in a corresponding direction in order to identify an item or icon displayed on a display. The joystick may also allow for the selection of the identified item or icon, for example, by depressing the joystick. Other user input devices are known, including trackpads and/or touch-sensitive displays, which allow a user to input directions via a finger or stylus for identifying and selecting items or icons displayed on a display.

The small displays associated with handheld or mobile devices provide a very limited area in which to display text and/or icons. This limits amount of content which may be displayed, as well as limiting the richness of such content. The limited size and number of user interface controls associated with handheld or mobile devices have been perceived as further limiting the amount of content which may be displayed, as well as limiting the richness of such content. Such constraints hinder the ability to provide a satisfactory user experience that encourages the use of such devices by potential players of matching type games, such as lotteries and/or “scratch and match” type games.

### BRIEF SUMMARY OF THE INVENTION

A user interface facilitates the presentation and/or playing of matching games on small displays commonly associated with handheld or mobile communications devices. In one aspect, identification of a name from a list of available picks causes the presentation of an image or graphic directly or indirectly associated with the identified name. Thus, identification of a sports team may display a team logo or sponsor logo, or identification of a corporate name may display a corporate logo or sponsor logo. The logo may replace the identified pick in the display, or be displayed in a separate field. Selection of the identified name is used to populate a field of a list of selected picks for comparison with a winning combination.

In one aspect, a method of implementing a user interface on a mobile device is provided, the method comprising: presenting a plurality of commercial entity designators, each of the plurality of commercial entity designators identifiable by a first user input and selectable by a second user input when identified, and in response to identification of one of the commercial entity designators by the first user input, presenting a commercial icon associated with the identified commercial entity designator.

In another aspect, a computer-readable medium storing instructions for causing a computer to facilitate a user interface suitable for playing a matching game on a mobile and/or handheld communications device, by: presenting a plurality of commercial entity designators, each of the plurality of commercial entity designators identifiable by a first user input and selectable by a second user input when identified; and in response to identification of one of the commercial entity designators by the first user input, presenting a commercial icon associated with the identified commercial entity designator.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic view of a host computing system communicating with a number of handheld or mobile communications devices via a network, such as a cellular network, according to one illustrated embodiment.

FIG. 1B is an isometric view of a handheld mobile communications device including a display and user input devices for implementing a user interface suitable for the presentation and playing of matching games, for example lottery or “scratch and match” type games, according to one illustrated embodiment.

FIG. 2A is a front view of a game card suitable for use in implementing matching games, according to one illustrated embodiment,.

FIG. 2B is a rear view of the game card of FIG. 2A.

FIG. 3A is a front view of a display of a handheld mobile communications device, showing a first or introductory page or screen of a user interface according to one illustrated embodiment.

FIGS. 3B-3F are front views of the display of FIG. 3A, showing a game page or screen of a user interface at a number of different intervals, illustrating the identification and selection of entity designators to populate fields of a user selected combination, where in response to the identification of a commercial entity designator, a commercial entity designator and/or icon is displayed in place of the commercial entity designator, according to one illustrated embodiment.

FIG. 3G is a front view of the display of FIG. 3A, showing a confirmation page or screen of a user interface according to one illustrated embodiment.

FIG. 4A is a front view of a display of a handheld mobile communications device, showing a game page or screen, wherein the entity designator in the list of available picks is replaced with a commercial icon of a sponsor of the entity represented by entity designator.

FIG. 4B is a front view of a display of a handheld mobile communications device, showing a game page or screen of a user interface wherein a commercial icon for a sponsor of an identified entity designator is display in a dedicated field.

FIG. 4C is a front view of a display of a handheld mobile communications device showing a game page or screen of a user interface according to another illustrated embodiment wherein the fields of the picked entity designators are represented as medal awarding podiums.

FIG. 4D is a front view of a display of a handheld mobile communications device, showing a game or screen of a user interface where the entity designators are individual players, for example PGA players, and where identification of one of the players causes the display of a commercial designator and/or icon of a sponsor in a dedicated field according to one illustrated embodiment.

FIG. 5 is a front view of a display of a handheld mobile communications device showing game page or screen of a user interface for presenting and playing a “scratch and match” type game according to a further illustrated embodiment.

FIG. 6 is a flow diagram showing a method of distributing game cards according to one illustrated embodiment, according to one illustrated embodiment.

FIGS. 7A-7B are a flow diagram showing a method of operating a handheld or mobile communications device to play a matching game, according to one illustrated embodiment.

FIG. 8 is a flow diagram showing a method of operating a host computing system for use in providing a matching game, according to one illustrated embodiment.

FIG. 9 is a flow diagram showing a method of populating entry fields according to one illustrated embodiment.

FIG. 10 is a flow diagram showing a method of populating entry fields in a user selected combination, according to another illustrated embodiment.

FIG. 11 is a flow diagram showing a method of operating a handheld or mobile communications device to play a matching game according to another illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with hand or mobile communications devices, networks including but not limited to cellular communications networks, and computing systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

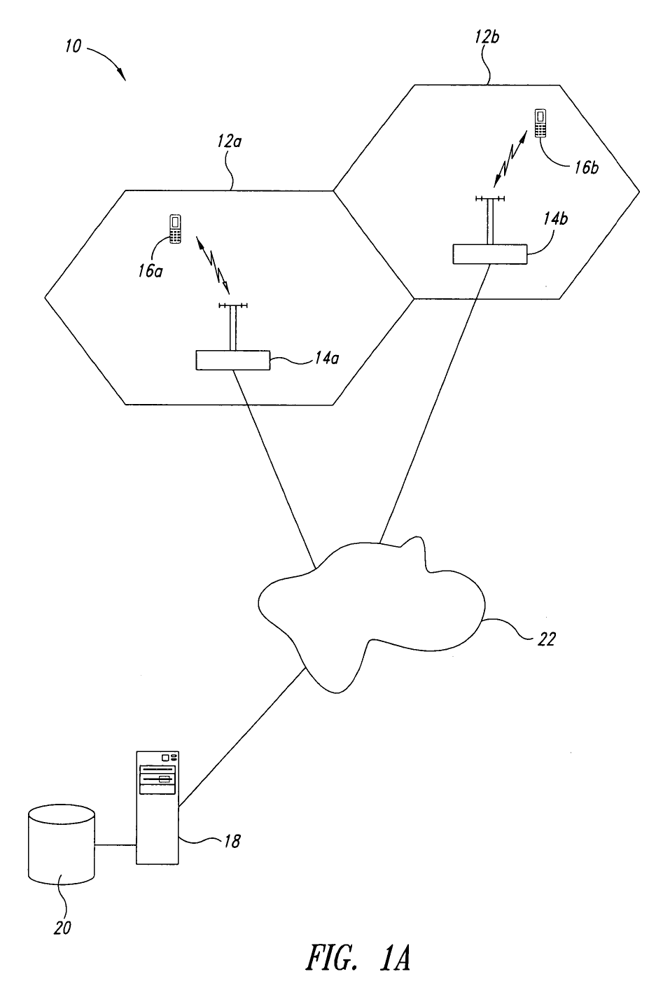

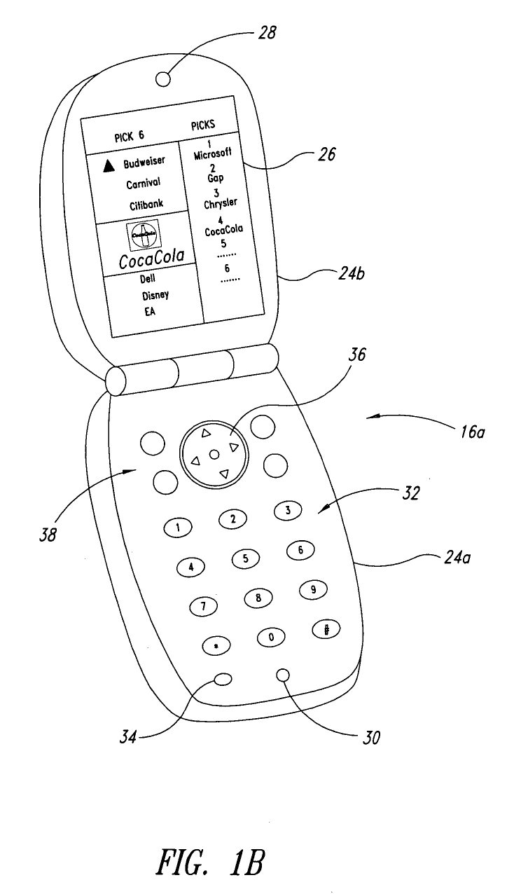

FIG. 1A shows a telecommunications environment 10 such as a cellular phone system including a number of cells 12a, 12b and respective base stations 14a, 14b used to provide wireless communications to handheld or mobile communications devices 16a, 16b. The telecommunications environment 10 may include a host computing system 18 and associated database 20 configured to implement a matching game as described in detail below. The host computing system 18 may communicate with the base stations 14a, 14b via a network 22 which may take any of a variety of forms including wired networks such as POTS and/or wireless networks such as a network provided under the GSM or PCS protocols.

FIG. 1B shows a handheld mobile communications device 16a according to one illustrated embodiment. The mobile communications device 16a may include a clamshell type housing having a lower section 24a and an upper section 24b. The upper section 24b may include a display 26 such as a liquid crystal display (LCD), and may include a speaker 28. The display 26 typically has relatively small dimensions, for example two inch by two inch or smaller. The lower portion 24a of the housing includes a speaker 30, as well as a number of user actuable controls. The controls may include keys of a standard keypad 32, each key corresponding to a respective one of the digits 0-9 and to two special symbols * and #, commonly found on keypads associated with telephones. The mobile communications device 16a may also include an ON/OFF switch, button key 34.

The mobile communications device 16a may further include one or more user input devices operable for identifying and/or selecting items or icons displayed on the display 26. For example, a scrolling mechanism such as joystick or rocker switch 36 may allow the user to scroll a cursor displayed in the display 26 to identify an item or icon. For example, the rocker switch 36 may toggle between two opposed directions, allowing the user to scroll a cursor in two orthogonal directions in the display 26. Alternatively, the rocker switch 36 may toggle in more than two opposed directions. For example, the rocker switch 36 may toggle forward, back, and left, right, allowing a user to scroll top, bottom, left, right, in the display 26, respectively. The rocker switch 36 may also be selectively actuable to select an item or icon indicated via the scrolling in the display 26. For example, the rocker switch 36 may be depressed to select an identified item or icon. The mobile communications device 16a may further include additional keys 38, for example, operable to display menus. While the scrolling mechanism is illustrated and discussed as a joystick or rocker switch, the scrolling mechanism may take any of variety of other forms, including, for example, a set of two or more keys that bear a defined physical relationship to one another. For example, selection of the key bearing the legend 2 may move the cursor up in the display 26, while selection of the key bearing the legend 8 may move the cursor down. Likewise, selection o the key bearing the legend 4 may move the cursor left in the display 26, while selection of the key bearing the legend 6 may move the cursor right. Other keys, or key combinations are possible. Alternatively, scrolling may be implemented based on a duration of key depression or number of times a key is depressed in a given period (e.g. single versus double clicking).

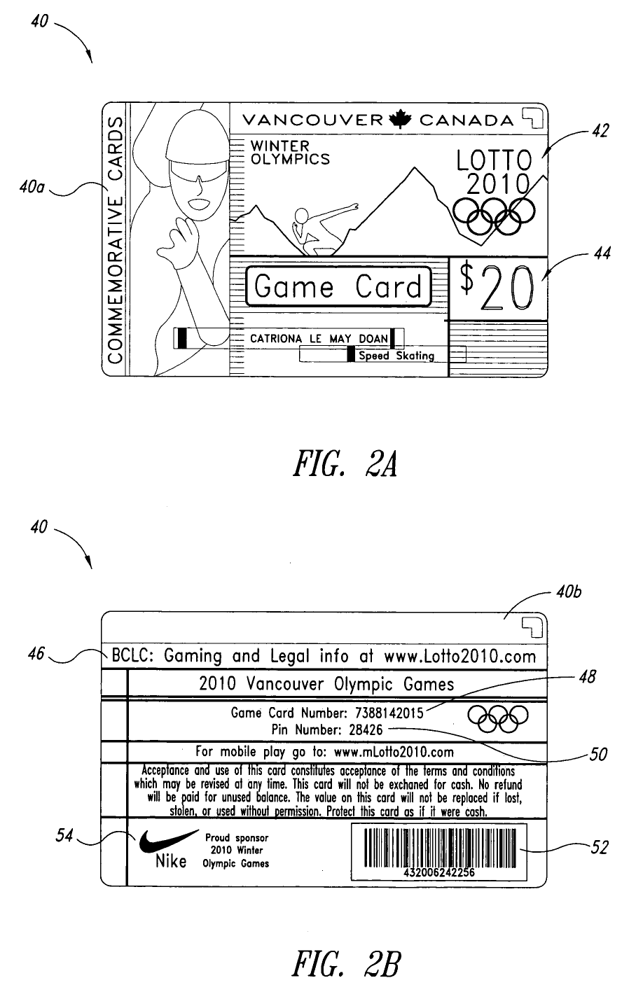

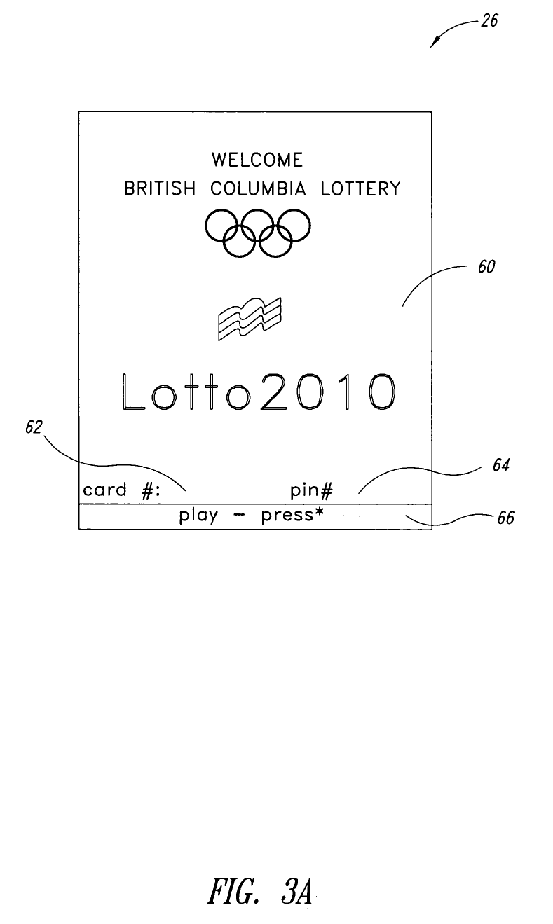

FIGS. 2A and 2B show a gaming card 40 which may be distributed at a vending outlet. The gaming card 40 may include a face 40a illustrated in FIG. 2A that identifies the card sponsor, for example a particular Olympic game 42. A game card 40 may also carry a denomination 44 indicating a monetary value represented by the game card 40. As illustrated in FIG. 2B, a back 40b the card 40 may include an indication of the authorized game authority 46, a unique game card number 48, a personal identification number or PIN 50. The back 42b may also bear a machine-readable symbol 52 allowing the game card 40 to be easily scanned, and a sponsor logo or other advertising 54.

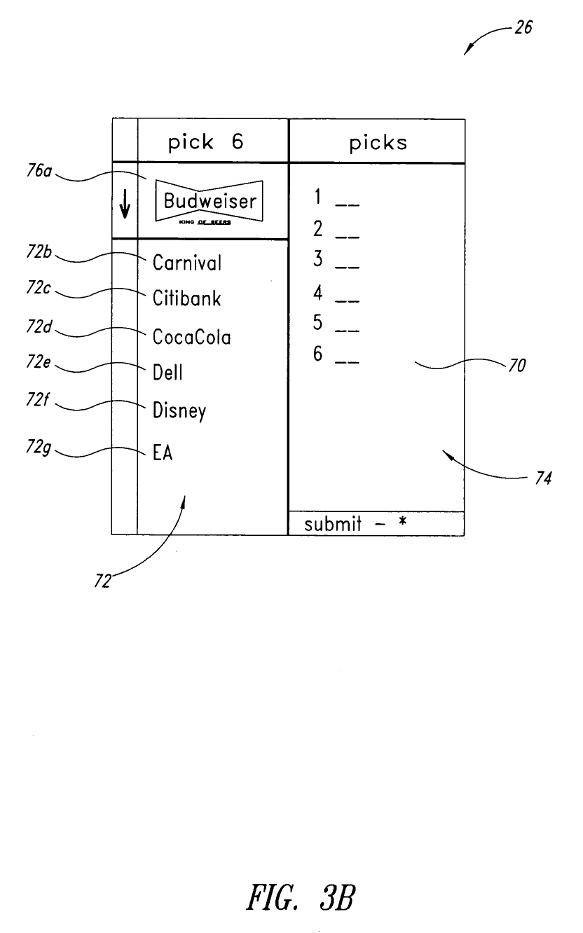

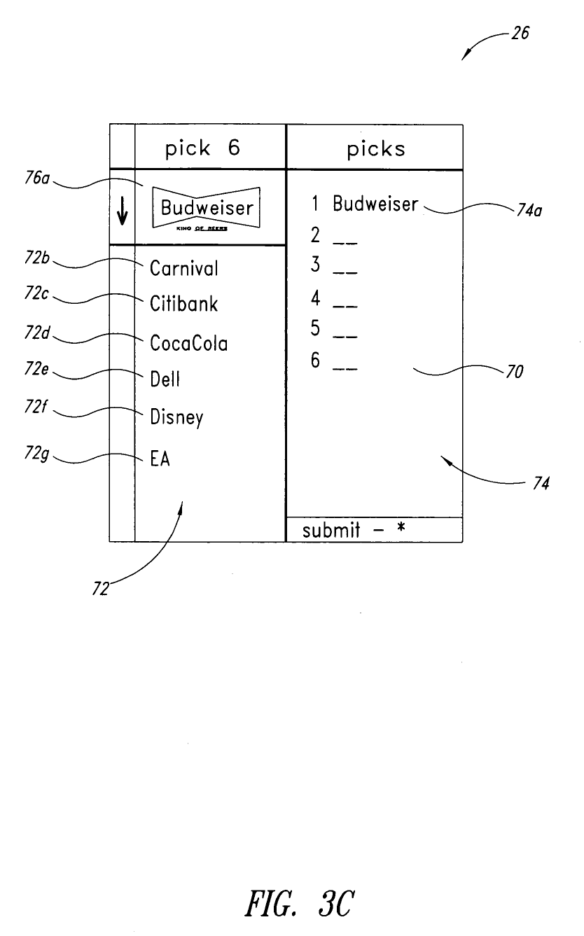

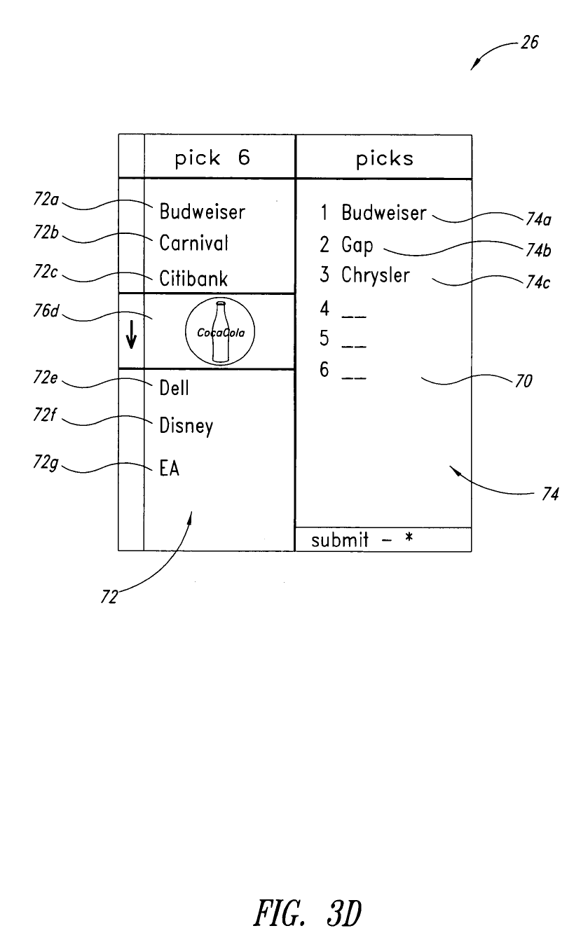

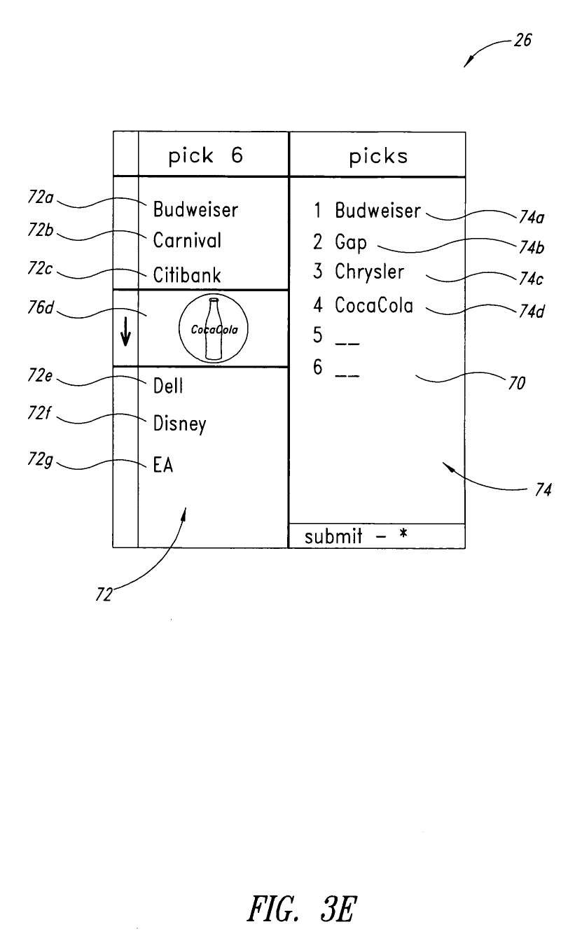

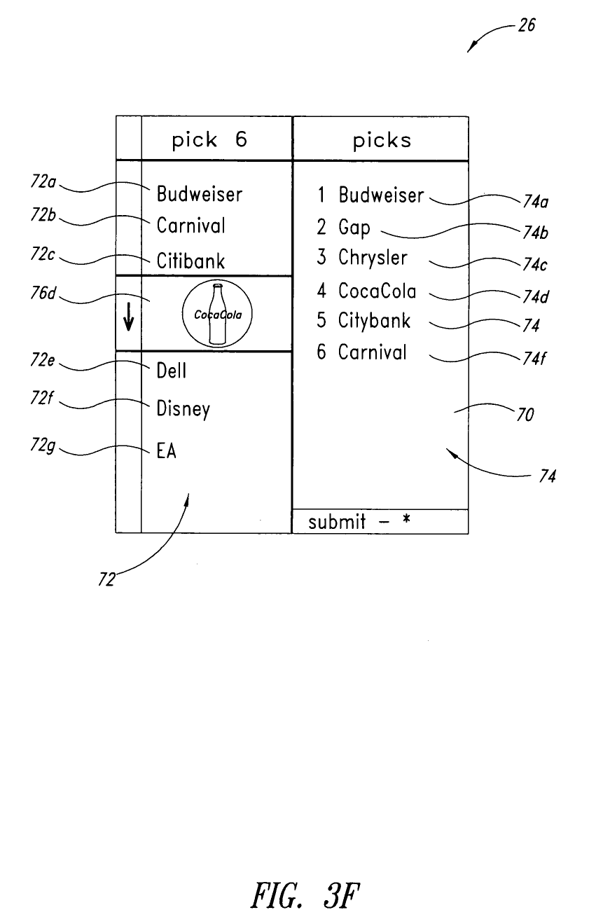

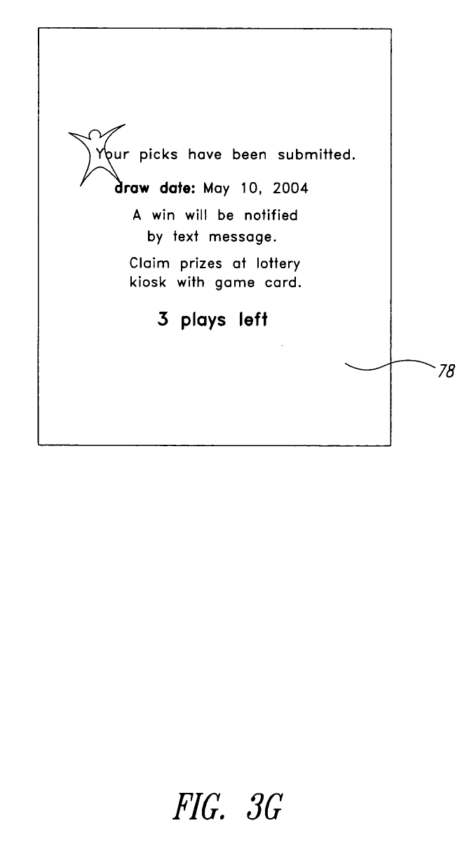

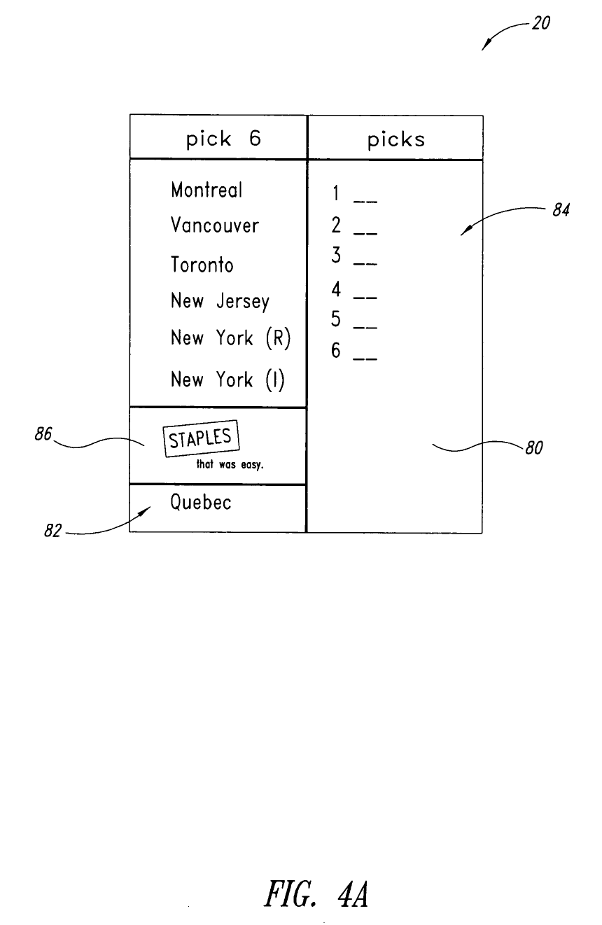

FIG. 3A shows the display 26 displaying an introduction screen 60. The introduction screen 60 may have a card number entry field 62 and a pin number entry field 64 for entering the card number 48 and/or PIN 50 (FIG. 2B) which may be found on the rear or back 40b of the game card 40. The introduction screen 60 may also include directions to press a particular key, for example the key bearing the * symbol, or some other key, to enter or submit the card number 48 and/or PIN 50.

FIGS. 3B-3F shows the display 26 displaying a game screen or page 70 for playing a matching game. In one embodiment, the game involves the selection of a number of sponsors of a player, team, game, arena, tournament or other entity or event, in an attempt to match a winning combination.

Entity designators 72a-72g for each of the sponsors who may be picked are displayed, for example, in a list of available picks 72, while the entity designator for each selected sponsor is displayed in a list of selected picks 74. The entity designator 72a-72g may, for example, take the form of a printed name of the sponsor. The entity designator 72a-72g may take other suitable forms such that a number of the entity designators are displayable within the limited area of the display 26 at sufficient resolution to be read.

The user may scroll down the list of available picks 72 using a first type of user input. For example, the user may toggle the rocker switch 36 (FIG. 1B) in a first direction (e.g., forward or back). As the user scrolls the down the list of available picks 72, successively identifying or indicating sponsors, the sponsor's entity designator 72a-72g is replaced in the pick from list of available picks 72 by a commercial icon, for example a logo, or graphic logo of the sponsor's trademark. Thus, as illustrated in FIG. 3B, when the entity designator of the sponsor Budweiser is indicated, the typed or printed name Budweiser is replaced in the list of available picks 72 by a commercial icon 76a in the form of a graphic image of the Budweiser trademark or logo. The other entity designators 72b-72g may be shifted in the list of available picks 72 to accommodate the commercial icon 76a. As illustrated in FIG. 3C, upon a user input of a second type, the indicated sponsor Budweiser is selected and added to a field 74a in the list of selected picks 74.

As illustrated in FIG. 3D, the user can scroll to the entity designator 72d of another sponsor, for example Coca-Cola. In response, the user interface displays that commercial icon 76d, in the form of the sponsor's logo, in the list of available picks 72. As illustrated in FIG. 3E, a user input of a second type adds the entity designator 74d to the list of selected picks 74. After all of the fields of the list of selected picks 74 have been populated as illustrated in FIG. 3F, the user may press a key, for example special function key *, to submit the list of selected picks 74. As discussed in detail below, such action, may include the wireless submission of a packet to the host computing system 18 for evaluation of the selected combination to a winning combination. Communications may be implemented using short message service of various telecommunications providers.

FIG. 3G shows a confirmation screen or page 78 which may be presented to the user in response to the submission of the selected combination 74a-74f, confirming that the list of selected picks 74 were successfully submitted.

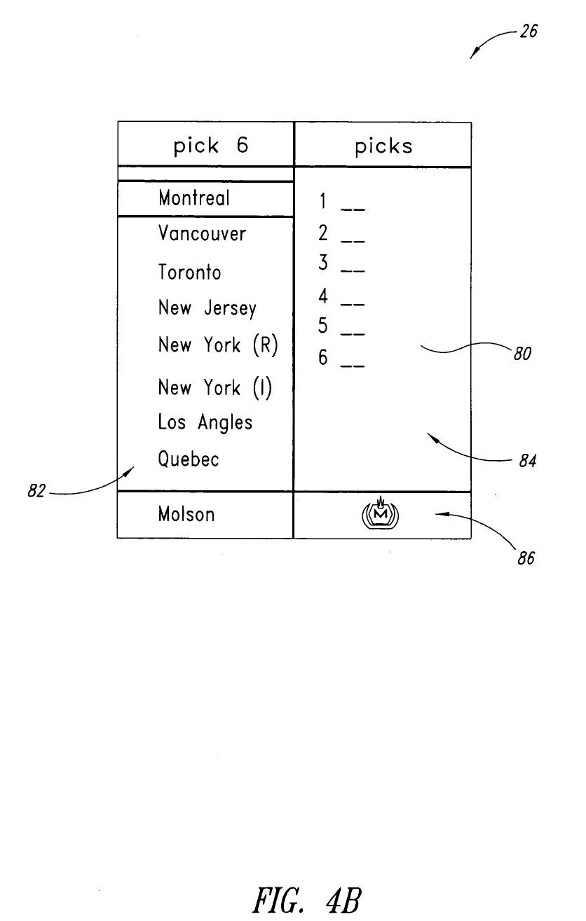

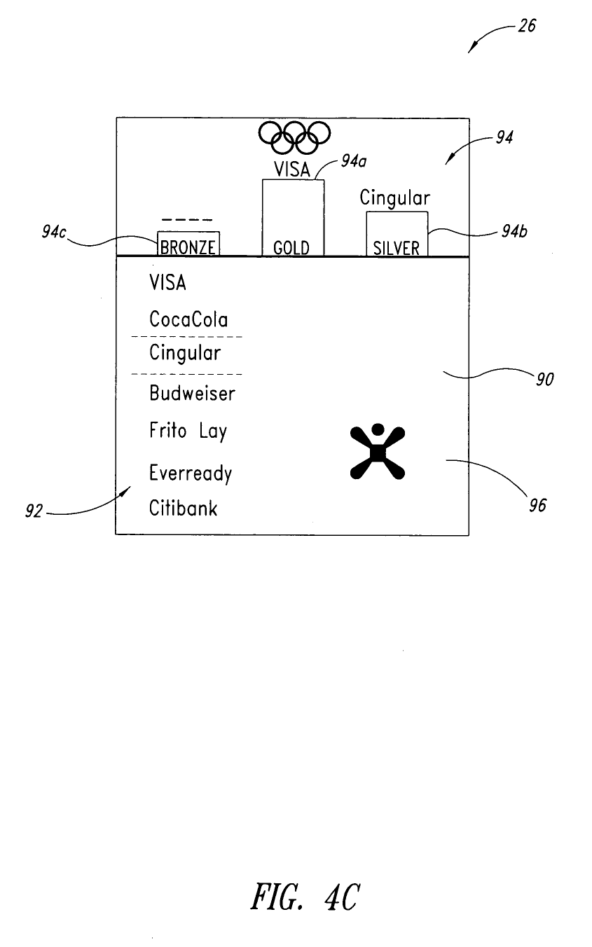

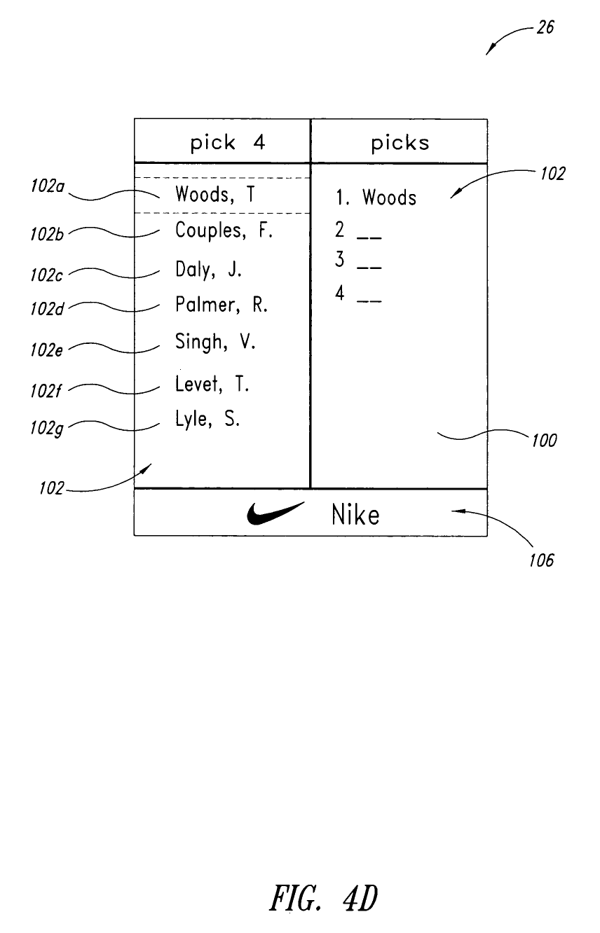

FIGS. 4A and 4B show other embodiment employing sports teams, for example National Hockey League teams. In the embodiments of FIG. 4A and 4B, the game screen or page 80 displays a list of available picks 82, for example NHL team names, while the selected teams are displayed in a list of selected picks 84.

In contrast to the previous embodiment (FIGS. 3B-3F), when identified by the user, the user interface of the embodiment of FIG. 4A replaces the entity designator in the list of available picks 82 with a commercial icon 86 of a sponsor of the entity represented by entity designator. For example, the entity designator for a sports team, may be replaced with the commercial icon of a sponsor of an arena or stadium where the sports team plays. Thus, in the example illustrated in FIG. 4A, a commercial icon for STAPLES replaces the entity designator for the Los Angles Kings, since Staples owns or has licensed the naming rights for the arena in which the Los Angles Kings play. Similarly, the Toronto entity designator may be replaced with Air Canada commercial icon when identified, or Washington Capitals entity designator replaced with an MCI commercial icon. In each case, the commercial icon may function as a link or “hot-link” which may automatically hyperlink the user to a corresponding Website or Webpage, if and when selected by a third type of user input.

In contrast to the previous embodiment (FIG. 4A), the user interface of the embodiment of FIG. 4B causes the display a commercial icon of a sponsor of the identified entity designator in a dedicated field 86, instead of, or in addition to, displaying the commercial icon in place of the entity designator in the list of available picks 82. As illustrated in FIG. 4B, the display of the commercial icon in the dedicated field 86 may include the display of the sponsor's name as well as the sponsor's logo or graphic trademark.

FIG. 4C shows a display 26 of a handheld or mobile communications device 16a including a user interface for displaying a game page or screen 90 according to another illustrated embodiment. In this game, the user may select from a list of available picks 92 to populate a number of fields of a list of selected picks 94 represented as medal podiums, for example three podiums 94a, 94b, 94c representing first, second and third place, gold, silver and bronze medals, or win, place and show finishes. Similarly to the embodiment of FIG. 4B, identification of an entity designator from a list 92 causes the display of a logo in a separate field 96.

FIG. 4D shows a display 26 of a handheld or mobile communications device 16a including a user interface for displaying a game page 100 associated with another game employing sports figures or players. In this game, the user may identify and select from a list of available picks 102, including entity designators 102a-102g to populate the fields of a list of selected picks 102. In this example, the entity designators of the list of available picks 102 are illustrated as the names of professional golf association players. The user can scroll down the list of available picks 102 to identify a specific player as previously discussed. In response to identification of an entity designator, a commercial icon representing a logo or trademark of the sponsor of the player or a tournament identified by the entity designator is displayed in a dedicated field 106.

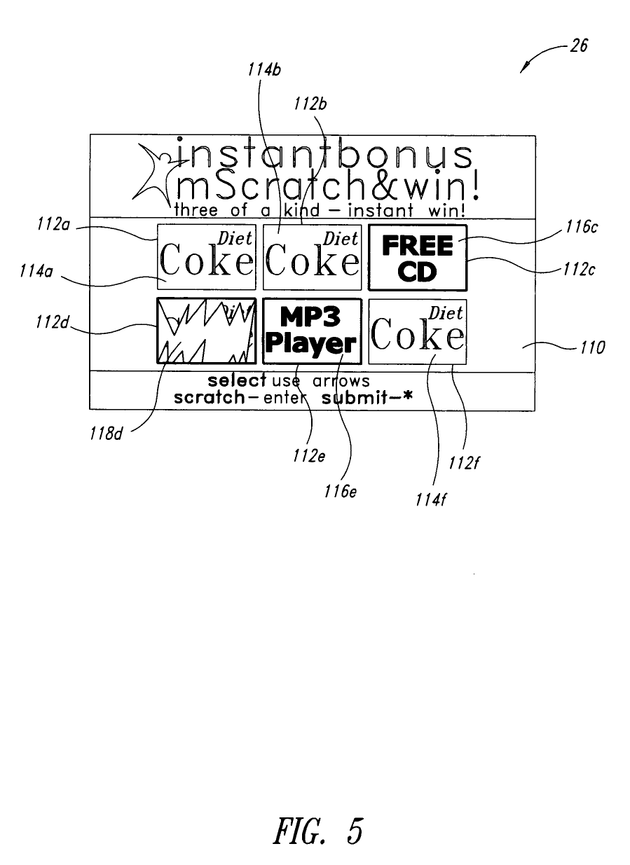

FIG. 5 shows a display 26 of a handheld or mobile communications device 16a including a user interface for displaying a game page or screen 110 for playing a scratch and match game according to another illustrated embodiment.

The game page 110 includes a number of user-selectable fields 112a-112f. Each of the fields initially displays a commercial icon. Thus, for example, the fields 112a, 112b and 112f display a commercial icon 114a, 114b, 114c representing the Diet Coke. In response to identification and/or selection of a field by the user, the commercial icon is replaced by an award icon, such as the award icons 116c, 116e represented in fields 112c, 112e. Thus, for example, the user may identify and select field 112d. In response, the user interface replaces the display of the commercial icon with the reward icon. Such can include visual effects, such as visual replicating the removal of an overlying layer by scratching 118d, and/or other visual effects. Award of the prize still requires matching. For example, the user may be entitled to the prize represented by the award icon if a defined number of the award icons match one another. For example, the game may require the user have three matching award icons. Thus, if the award icon in field 112d is MP3PLAYER, the user will be awarded an MP3 player since the award icon will match the award icons 116c, 116e. Alternatively, the game may require the underlying icons to match some defined combination rather than each other. For example, the game may require the underlying icons to form a rebus or other puzzle.

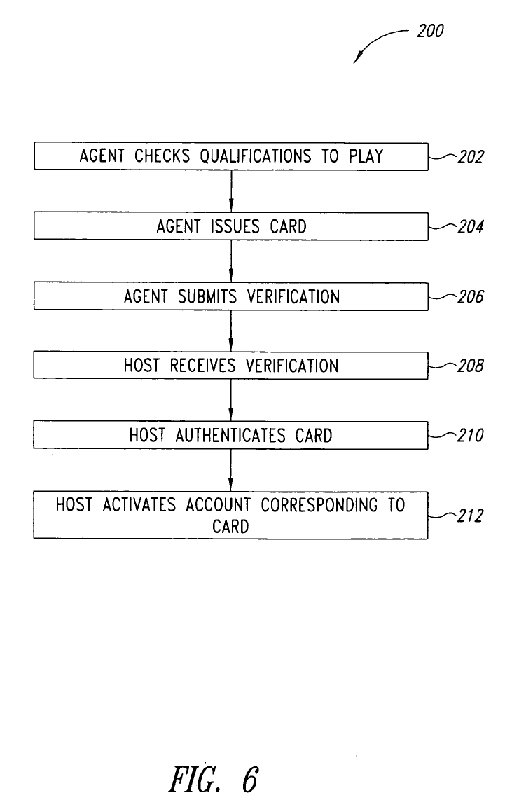

FIG. 6 shows a method 200 of issuing a game card 40 according to one illustrated embodiment. At 202, an agent checks the qualifications of a game card purchaser to play the game. For example, the agent may check the age and/or residence of the potential purchaser. The agent may check identification material, for example a driver's license or other government issued identification card, to establish that the potential purchaser meets legal qualifications to play the game, for example being 18 years or older and/or being a resident of the state or province. Upon verification, the agent issues the game card 40 to the purchaser. At 206, the agent submits verification information, for example electronically submitting verification information to the host computing system 18. For example, the agent may select or otherwise indicate that legal qualifications have been verified and/or may submit evidence of such verification. The machine-readable symbol 52 carried by the game card 40 may facilitate such submission.

At 208, the host computing system 18 receives the verification from the agent. At 210, the host computing system 18 authenticates the game card 40 sold or otherwise distributed by the agent. At 212, the host computing system 18 activates an account corresponding to the game card 40. The account may, for example, be identified by the game card number, the game card number in combination with a pin number, an identifier encoded in the machine-readable symbol 52 or some other value.

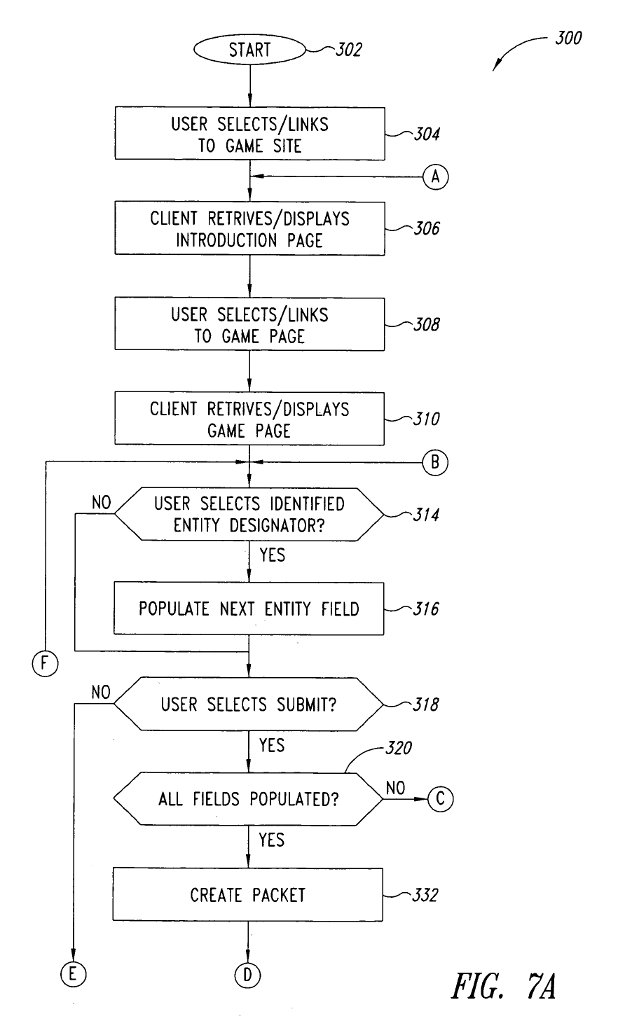

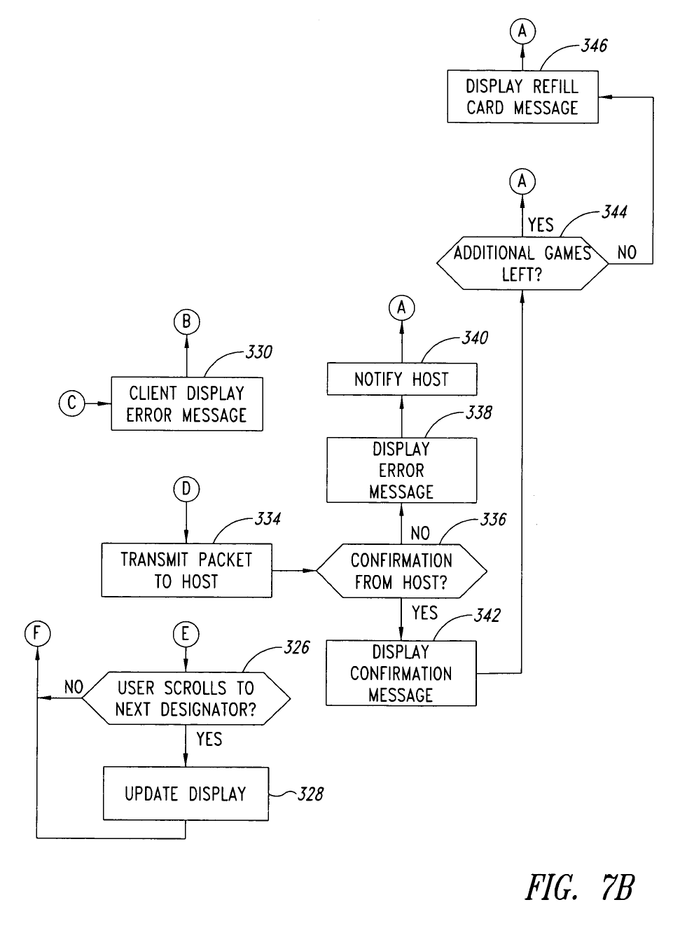

FIGS. 7A and 7B illustrate a method 300 of operating the handheld or mobile communications device or client 16a according to one illustrated embodiment starting at 302.

At 304, the user selects or hyperlinks to a game site. At 306, the handheld or mobile communications device or client 16a retrieves and/or displays the introduction page (e.g., 60). At 308, the user selects or hyperlinks to a game page (e.g., 70, 80, 90, 100, 110). At 310, the handheld or mobile communications device or client 16a retrieves and/or displays the game page.

At 314, the handheld or mobile communications device or client 16a determines whether the user has selected an identified entity designator. If the user has identified an entity designator, the handheld or mobile communications device or client 16a populates a next entry field at 316 in the list of selected picks, and passing control to 318. Otherwise, control passes directly to 318.

At 318, the handheld or mobile communications device or client 16a determines whether the user has selected to submit the list of selected picks. If the user has selected to submit at 318, then control passes to 320 where the handheld or mobile communications device or client 16a determines whether all the fields in the list of selected picks have been populated. Otherwise control passes to 326.

At 326, the handheld or mobile communications device or client 16a determines whether the user has scrolled to a next entity designator. If the user has not scrolled to a next entity designator at 326, control passes back to 314. If the user has scrolled to a next entity designator, then the handheld or mobile communications device or client 16a updates the display 26 at 328, and returns control to 314.

If it is determined at 320 that all fields are not populated, the handheld or mobile communications device or client 16a displays an error message at 330 and passes control back to 314. If, however, it is determined that all fields of the list of selected picks are populated in 320, then the handheld or mobile communications device or client 16a creates a packet at 332 for submission to the host computing system 18. The packet includes an indication of the user-selected picks and may additionally include the game card number and/or pin number. The packet may be encrypted and other security measures applied. Additionally, the packet may only be useful if received as a single integral packet to ensure that the contents of the packet have not been tampered with. At 334, the handheld or mobile communications device or client 16a transmits the packet to the host computing system 18.

At 336, the handheld or mobile communications device or client 16a determines whether it has received a confirmation from the host computing system 18. If a confirmation is not received, for example within some defined period, the handheld or mobile communications device or client 16a displays an error message at 338, notifies the host at 340, and returns control to 306. If the handheld or mobile communications device or client 16a has received a confirmation from the host computing system 18, the handheld or mobile communications device or client 16a displays a confirming message (e.g., page 78, FIG. 3F) at 342.

The handheld or mobile communications device or client 16a then determines whether additional games are left on the game card 40 at 344. For example, where each game is priced at two dollars, and the game card 40 was valued at twenty dollars, ten games can be played. If additional games are left, control returns to 306. If additional games are not remaining, the handheld or mobile communications device or client 16a displays an appropriate message at 346 and returns control to 306. The appropriate message may take the form of a message to refill the game card 40 or to purchase additional game cards 40.

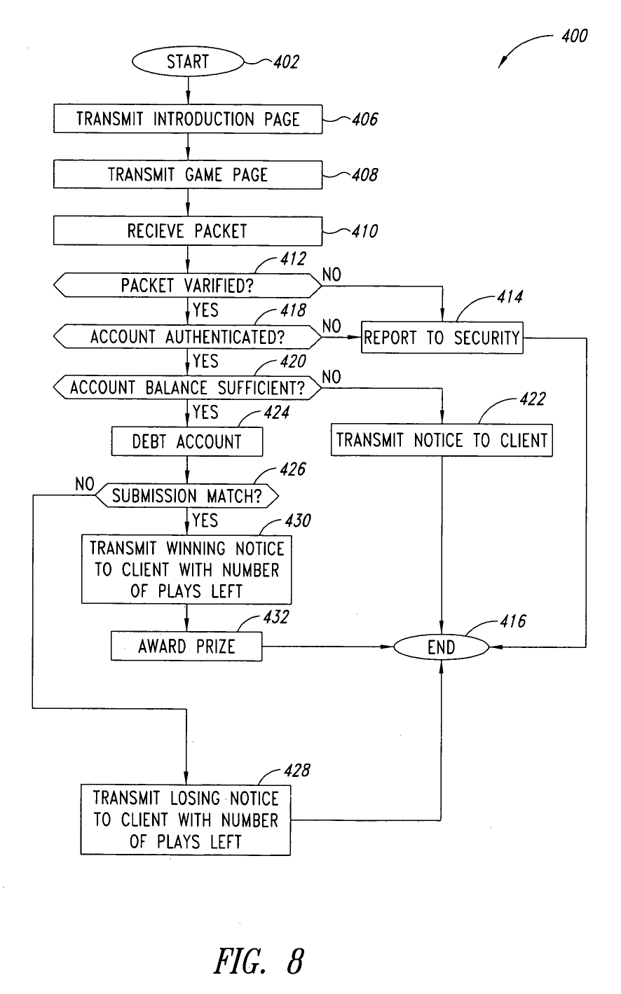

FIG. 8 shows a method 400 of operating the host computing system 18 according to one illustrated embodiment starting at 402.

At 406, the host computing system 18 transmits an introduction page (e.g., page 60, FIG. 3A). This may, for example, be in response to a request from a handheld or mobile communications device 16a, 16b, such as an HTTP GET REQUEST. At 408, the host computing system 18 transmits a game page (e.g., 60, 70, 80, 90, 110) in response to the request.

At 410, the host computing system 18 receives a packet from the handheld or mobile communications device 16a. At 412, the host computing system 18 verifies the packet. For example, the host computing system 18 may verify that the packet is complete, and was received without errors or tampering, for example employing one or more checksum characters and/or encryption algorithms. If the host computing system 18 determines that the packet cannot be verified, the host computing system 18 can report the anomaly to security at 414, and terminate the method 400 at 416. This may allow security personnel and/or systems to detect illegal or prohibited attempts to cheat.

If the packet is verified at 412, the host computing system 18 authenticates the account at 418. For example the host computing system 18 may determine whether the account has be set up, whether the card number and/or pin submitted as part of the packet match each other and/or are activated, and/or whether sufficient evidence of qualifications to play has been obtained. If the account is not authenticated, the host computing system 18 can report such to security at 414. If the account is authenticated, the host computing system 18 determines at 420 whether the account balance is sufficient to play the game. If the account balance is insufficient, the host computing system 18 transmits a message or notice to the handheld or mobile communications device or client 16a at 422, terminating at 416. If the account balance is sufficient, the host computing system 18 debits the account at 424.

At 426, the host computing system 18 determines whether the submitted combination (i.e., list of selected picks) matches at least a portion of a winning combination. The winning combination may be determined, for example using pseudo-random number generator to produce one or more pseudo-random numbers. Matching may require matching some, but not all of the fields of the submitted combination with some, but not all of the fields of the winning combination. For example, prizes may be awarded for matching three, four, or five fields of a six field winning combination. The winning combination may be previously defined or may be defined after submission of the submitted combination, and may be defined using non-pseudo-random methodologies.

If the submitted combination does not match the winning combination, the host computing system 18 transmits a losing notice to the wireless communications device or client 16a at 428. The notice may also include an indication of the number of plays left or remaining on the game card 40. If at least a portion of the submitted combination matches the winning combination, the host computing system 18 transmits a winning notification to the wireless communications device or client 16a at 430. The winning notification may include an indication of the number of plays left or remaining on the game card 40.

At 432, a prize is awarded. The prize may be awarded automatically, for example crediting the account for additional game plays, or transferring funds to an account. Alternatively, the award of the prize may require the game player to physically appear at a redemption center or game card distribution outlet or sponsor retail site.

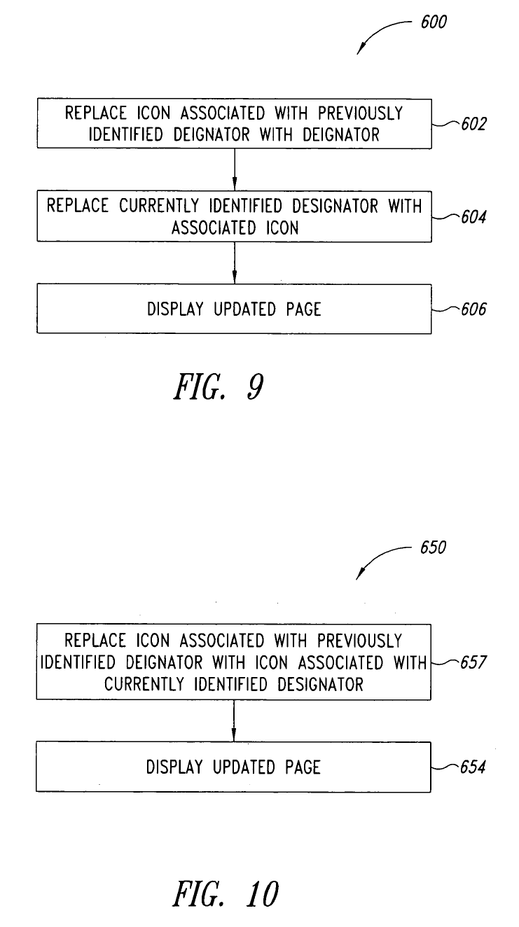

FIG. 9 shows a method 600 of populating the next entry field (316 of FIGS. 7A-7B) in a list of selected picks, according to illustrated embodiment. The method 600 is suitable for use with the user interfaces of the embodiments illustrated in FIGS. 3B-3F, and 4A, which substitute the commercial icons for the entity designators in the list of available picks.

At 602, the handheld or mobile communications device or client 16a replaces a commercial icon associated with a previously identified entity designator with the corresponding entity designator. At 604, the handheld or mobile communications device or client 16a replaces the currently identified entity designator with an associated commercial icon. At 602, the handheld or mobile communications device or client 16a displays the updated game page or screen (e.g., 70, 80, 90, 100, 110).

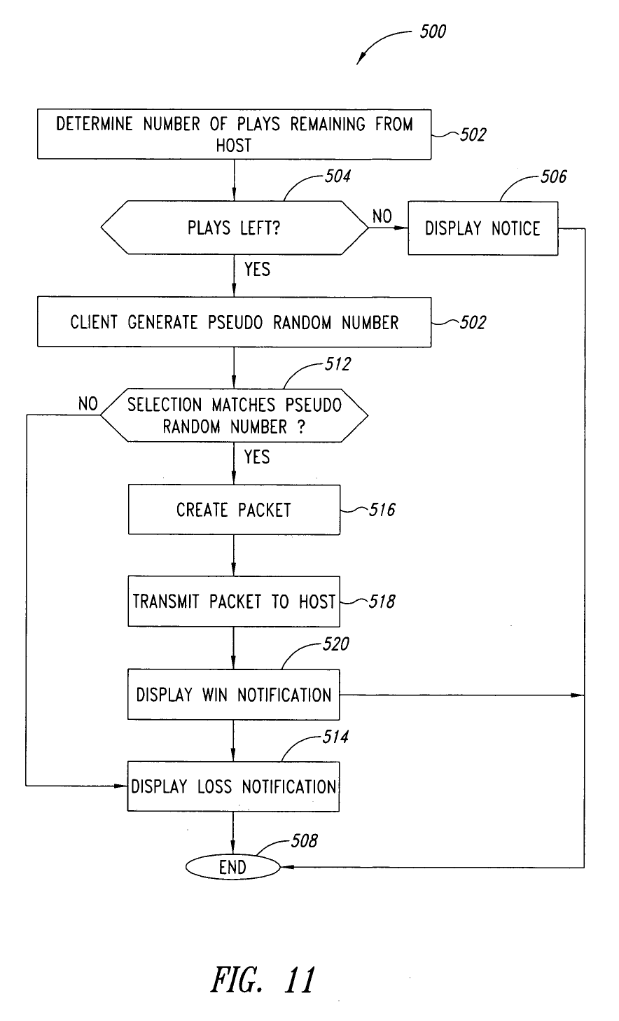

FIG. 10 shows a method 650 of populating a next entry field according to another illustrated embodiment. The method 650 is suitable for use with the user interfaces of the embodiments illustrated in FIGS. 4B, 4C, and 4D, which employ a dedicated field for display of the commercial icons.

At 652, the handheld or mobile communications device or client 16a replaces the icon associated with a previously identified designator with an icon associated with a currently identified designator. At 654, the handheld or mobile communications device or client 16a updates the game page or screen (e.g., 70, 80, 90, 100, 110).

FIG. 11 shows a method 500 of operating the handheld or mobile communications device or client 16a according to another illustrated embodiment. In particular, the method 500 generates the winning combination on the handheld or mobile communications device or client 16a itself, rather than by the host computing system 18. This approach may advantageously reduce the number of communications that must take place between the handheld or mobile communications device or client 16a and host computing system 18, which may significantly reduce charges associated with such, for example charges associated with the use of short message services. This approach may also advantageously distribute the functionality, reducing the overhead associated with such a system.

At 502, the wireless communications device or client 16a determines the number of plays remaining. For example, the wireless communications device or client 16a can confirm the number of games remaining with the host computing system 18. At 504, if the wireless communications device determines that there are no games left or remaining on the game card 40, the wireless communications device or client 16a displays an appropriate notice at 506 and the method 500 terminates at 508.

If games are left or remaining on the game card 40, a processor of the handheld or mobile communications device or client 16a may generate a pseudo-random number at 510. At 512, the handheld or mobile communications device or client 16a determines whether the pseudo-random number matches the selected combination. If the selected combination does not match the pseudo-random number, the handheld or mobile communications device or client 16a displays a lost notice at 514 and terminates at 508. If, however, the selected combination or a portion thereof matches the pseudo-random number, the handheld or mobile communications device or client 16a creates a packet at 516. At 518, the handheld or mobile communications device or client 16a transmits the packet to the host computing system 18. At 520, the handheld or mobile communications device or client 16a displays a winning notification and terminates at 508.

The above described embodiments may allow the successfully implementation of matching games such as lotteries and/or scratch and match games using handheld and/or mobile communications devices. While such concepts are not necessarily limited to devices having relatively small display areas, the potential benefits provided by this approach are most valuable in such an environment. Facilitating such in the handheld or mobile environment may produce sufficient interest to allow such gaming to be implemented in the non-handheld or fixed environments.

The above described embodiments also foster the use of sponsors and advertisers, whether direct or indirect. For example, the embodiments may foster the use of direct sponsors, such as corporations and other entities willing to pay some portion of the costs of the gamine itself in return for the advertising benefits associated with sponsorship. Also example, the embodiments may foster the use of indirect sponsors, such as corporations and other entities willing to pay some portion of the costs of a sporting event such as an Olympic Game or golf tournament, where the game is itself sponsor by the committee or other group sponsoring the sporting event. Additionally for example, the embodiment may foster the use of indirect sponsors, such as where an entity having naming rights to a sports arena or stadium is rewarded for such through the sponsorship of a game by a sports team or owner of the arena or stadium facilities. Thus, these embodiments allow various entities to garner sponsorships in order to defray actual operating costs. These embodiments also provide a novel and potentially lucrative approach to advertising, for example, where multiple otherwise unrelated advertisers may pool resources in order to gain consumer's attention. Additionally, the sponsors or advertisers can be assured that their logos are being seen by an attentive consumer, who is actually paying attention to the content of the game.

The use of short message service may be of interest to one or more telecommunications providers, who may wish to increase use of their particular service, and thus willing to sponsor all or a portion of a game. For example, such providers may be willing to contribute prizes such as minutes or cellular telephones to be given away as prizes

Upon initial display of a game page, the first entity designator in the list of available picks will typically be identified (e.g. cursor will be on top most entity designator in pick) and hence the associated commercial icon displayed, other variations are possible. This may justify an extra charge to receive the top position in the list of available picks. Other approaches are possible, for example, no entity designator may be initially identified. Alternatively, the initially identified entity designator may increment from game-to-game, or may be chosen randomly, or by weighted selection. As a further alternative, the order of the list of available picks may be randomly chosen or chosen by weighted selection.

In event a further embodiment, matching may be with respect to a position of a user controlled icon on the display 26. For example, the user may manipulate a position of an icon representing a goalie or other player. The handheld or mobile communications device 16a or host computing system 18 and generate the winning position, and compare the position of selected by the user with the winning position. Such an embodiment may be implemented, for example, as a shoot out in soccer or football.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other communications systems, devices and games, not necessarily the exemplary wireless communications devices and matching games generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the invention can be modified, if necessary, to employ systems, circuits and concepts of the various patents, applications and publications to provide yet further embodiments of the invention.

These and other changes can be made to the embodiments in light of the above-detailed description. In general, in the following claims, the terms used should not be construed to limit the invention to the specific embodiments disclosed in the specification and the claims, but should be construed to include all systems, devices, user interfaces and games that operate in accordance with the claims. Accordingly, the invention is not limited by the disclosure, but instead its scope is to be determined entirely by the following claims.

I/we claim:

1. A method of implementing a user interface suitable for playing a matching game on a mobile and/or handheld communications device, the method comprising:
presenting a plurality of commercial entity designators, each of the plurality of commercial entity designators identifiable by a first user input and selectable by a second user input when identified; and
in response to identification of one of the commercial entity designators by the first user input, presenting a commercial icon associated with the identified commercial entity designator.

2. The method of claim 1 wherein presenting a plurality of user commercial entity designators comprises displaying a list of alphanumeric character representations of commercial entities.

3. The method of claim 2 wherein displaying a list of alphanumeric character representations of commercial entities comprises displaying a list of names of commercial entities.

4. The method of claim 3 wherein displaying a list of names of commercial entities comprises displaying a scrollable list of names of commercial entities.

5. The method of claim 1 wherein presenting a commercial icon associated with the identified commercial entity designator comprises presenting a graphic commercial icon.

6. The method of claim 1 wherein presenting a commercial icon associated with the identified commercial entity designator comprises presenting a graphic commercial icon in place of the identified commercial entity designator.

7. The method of claim 1 wherein presenting a commercial icon associated with the identified commercial entity designator comprises presenting a graphic commercial icon in an area separate from the identified commercial entity designator.

8. The method of claim 1 wherein presenting a commercial icon associated with the identified commercial entity designator comprises presenting a commercial icon representing a trademark associated with a commercial entity represented by the commercial entity designator.

9. The method of claim 1 wherein presenting a commercial icon associated with the identified commercial entity designator comprises presenting a commercial icon representing a name of a sponsor associated with a commercial entity represented by the commercial entity designator.

10. The method of claim 1 wherein presenting a commercial icon associated with the identified commercial entity designator comprises presenting a commercial icon representing a trademark of a sponsor associated with a commercial entity represented by the commercial entity designator.

11. The method of claim 1 wherein the commercial entity designator represents a sports team and wherein presenting a commercial icon associated with the identified designator comprises presenting a commercial entity identifier of a commercial entity having naming rights to a facility at which the sports entity competes.

12. The method of claim 1, the method comprising:
in response to selection of an identified one of the commercial entity designators by the second user input, populating a field of a list of selected picks with a representation of the commercial entity designator.

13. The method of claim 12, further comprising:
in response to a user input indicative of a command to submit the list of selected picks, creating a packet including an identifier indicative of an identity of each of the selected commercial entity designators, and forwarding the packet to a host computing system for evaluation.

14. The method of claim 13, further comprising:
determining that all fields of the list of selected fields have been populated before creating the packet.

15. A computer-readable medium storing instructions for causing a computer to facilitate a user interface suitable for playing a matching game on a mobile and/or handheld communications device, by:
presenting a plurality of commercial entity designators, each of the plurality of commercial entity designators identifiable by a first user input and selectable by a second user input when identified; and
in response to identification of one of the commercial entity designators by the first user input, presenting a commercial icon associated with the identified commercial entity designator.

16. The computer-readable medium of claim 15 wherein displaying a list of alphanumeric character representations of commercial entities comprises displaying a scrollable list of names of commercial entities.

17. The computer-readable medium of claim 15 wherein presenting a commercial icon associated with the identified commercial entity designator comprises presenting a graphic commercial icon in place of the identified commercial entity designator.

18. The computer-readable medium of claim 15 wherein presenting a commercial icon associated with the identified commercial entity designator comprises presenting a graphic commercial icon in an area separate from the identified commercial entity designator.

19. The computer-readable medium of claim 15 wherein presenting a commercial icon associated with the identified commercial entity designator comprises presenting a commercial icon representing a trademark associated with a commercial entity represented by the commercial entity designator.

20. The computer-readable medium of claim 15 wherein presenting a commercial icon associated with the identified commercial entity designator comprises presenting a commercial icon representing a name of a sponsor associated with a commercial entity represented by the commercial entity designator.

21. The computer-readable medium of claim 15 wherein the instructions cause the computer to facilitate a user interface suitable for playing a matching game on a mobile and/or handheld communications device, further by:
in response to selection of an identified one of the commercial entity designators by the second user input, populating a field of a list of selected picks with a representation of the commercial entity designator.
